(19) United States
(12) Patent Application Publication
(10) Pub. No.: US 2026/0340386 A1
(43) Pub. Date: Oct. 29, 2026

(54) Low-Rank Adaptation for AI-Based Drug Discovery and Development

(71) Applicant: Stephen Gbejule Odaibo, Sugar Land, TX (US)

(72) Inventor: Stephen Gbejule Odaibo, Sugar Land, TX (US)

(73) Assignee: Deep EigenMatics, Inc., Sugar Land, TX (US)

(21) Appl. No.: 19/711,938

(22) Filed: Jun. 17, 2026

(51) Int. Cl. G06N 3/08

(52) U.S. Cl. CPC G06N 3/08

(57) ABSTRACT

Methods and systems are disclosed for fine-tuning a pre-trained neural network for an AI-based drug discovery and development task using low-rank adaptation. In one embodiment, a weight update matrix associated with a pre-trained weight matrix of the neural network is expressed as a summation of outer product matrices whose ranks form a composition of a selected low rank, the composition being uniform, non-uniform, or a single full-rank component. The outer product matrices are trained successively: an outer loop designates one outer product matrix at a time as a learnable parameter matrix while freezing the pre-trained weight matrix, and an inner loop iteratively updates the designated matrix until a stopping criterion is met, whereupon the trained matrix is added to the pre-trained weight matrix and a next outer product matrix is designated. The fine-tuned neural network generates candidate ligand representations, including peptides and small-molecule drugs for synthesis.

### FIELD OF THE INVENTION

The present invention relates generally to Artificial Intelligence (AI) and Machine Learning (ML) methods for protein and drug ligand design, and specifically to fine-tuning of neural networks for protein and drug design.

### BACKGROUND OF THE INVENTION

The research and development pipeline for new drugs is tremendously expensive and lengthy, often costing over $2 billion and more than 10 years to get a single candidate drug through clinical testing phases. Yet despite the exorbitant investment of time and resources, a high percentage of drugs fail in the clinical testing phases.

Furthermore, it is highly resource intensive to train neural networks for protein and drug design tasks. It requires large amounts of time and capital expenditure spent on computing resources such as graphics processing units. The Large Language Models (LLMs) that typically form the base of protein and drug design models can often be as large as several hundred billion parameters and up to a trillion parameters. Hence the energy, computation, time, and data expended on getting foundational models cannot readily and typically should not be replicated in a wheel reinvention sense.

As such, fine-tuning of pre-trained protein and language models is common practice. This however is subject to potential problems of its own such as catastrophic forgetting and computational costs. All the effort and resources that resulted in parametrization of specialized knowledge in the weights of a pre-trained model can be suddenly lost catastrophically upon attempting to fine-tune. The fine-tuning process itself is also expensive.

One method by which this has been addressed for general LLMs is Low-Rank Adaptation (LoRA), wherein instead of updating the full rank of the weight matrices, a product of two low rank matrices is used, wherein the dimension of the product is equal to the dimension of the weight matrix to be updated. Each respective low-rank factor matrix of the product is chosen to be significantly smaller than the weight matrix, hence conferring significant compute savings and mitigation against catastrophic forgetting.

Nonetheless, in the standard formulation of LoRA, computational cost and catastrophic forgetting still occur and remain a problem. This is of particular concern in the field of protein and drug design where the low availability of data, capital intensive nature of large model training, large size of required models, make catastrophic forgetting and capital intensiveness particularly devastating.

### OBJECTS OF THE INVENTION

It is an object of this invention to provide a system and method for protein and drug design using low-rank adaptation for fine-tuning of a pre-trained model.

Another object of this invention is to provide a system and method for protein and drug design using low-rank adaptation for fine-tuning of a pre-trained model, wherein LoRA is via successive training and summation of outer products.

Yet another object of the invention is to provide a system and method for protein and drug design using low-rank adaptation for fine-tuning of a pre-trained model, wherein LoRA is via successive training and summation of outer products, wherein the ranks of the components of the composition add up to the selected low rank, and wherein the composition is a design hyperparameter.

Yet another object of the invention is to provide a system and method for protein and drug design using low-rank adaptation for fine-tuning of a pre-trained model, wherein LoRA is via successive training and summation of outer products, wherein representation of a protein or drug can be generated and synthesized.

Yet other objects, advantages, and applications of the invention will be apparent from the specifications and drawings included herein.

### SUMMARY OF THE INVENTION

The instant application discloses a novel method to mitigate the aforementioned problems (catastrophic forgetting and computational cost) by leveraging a summation of outer products approach wherein a composition of the chosen low-rank is selected, and the corresponding outer product matrices across the composition are successively admitted as the learnable parameters.

As used herein and in the claims, the term “composition” of the selected low rank r means an ordered k-tuple of positive integer parts summing to r, with k ranging from 1 to r.

Upon each outer product subrank completing training, it is frozen in the sense of being added to the pre-trained (frozen) weights and thereby updating the pre-trained weights. At which point the next outer product in the summation is designated as the learnable parameters, and training proceeds iteratively till complete or stopping criteria are met. At which point the newly trained outer product weight matrix is added to the pre-trained weights, thereby updating the pre-trained weights.

Again, the learnable parameters are designated as the next outer product in the summation and the process proceeds as described, with an outer loop updating pre-trained weights and designating learnable parameters as the next outer product in the summation, and an inner loop comprising iteratively training the model, e.g. via backpropagation wherein pre-trained weights are frozen and unchanging and learnable parameters are iteratively updated, and the process proceeds till all the outer products in the sum are trained (or stopping criteria are met) and the process terminates.

The composition of the low-rank is a design specification which need not be uniform, can be irregular, or can comprise the full low-rank, r, at once.

The successive-summation low-rank adaptation disclosed herein provides a technical improvement to the functioning of neural network fine-tuning. Because the outer product matrices of the composition are trained successively rather than jointly, only a single designated outer product matrix is updated during any given inner loop, while the pre-trained weight matrix and all other outer product matrices remain frozen. Consequently, the number of learnable parameters held in an updatable state at any one time is reduced relative to both standard fine-tuning, in which substantially all weights of the model are updated, and relative to non-successive low-rank adaptation, in which all factors of the weight update are updated jointly. This reduction lowers the memory footprint and computational cost required for fine-tuning, and the freezing of previously trained outer product matrices upon their addition to the pre-trained weight matrix mitigates catastrophic forgetting of knowledge parametrized in the pre-trained weights. These improvements are improvements to the operation of the computer and to the technological process of adapting a pre-trained neural network, and are not merely the use of a computer as a tool to implement an abstract process.

Prior to this disclosure, there was no successive-summation low-rank adaptation method for fine-tuning neural networks for protein and drug design. As such the instant disclosure addresses a pressing unmet need.

The invention disclosed herein includes a method comprising low-rank adaptation for fine-tuning pre-trained models for protein and drug design.

In one embodiment of the invention, a pre-trained model for protein or drug design or other AI-based drug discovery and development task is received. Additional data for some specific drug discovery and development task is obtained and fine-tuning is conducted via low rank adaptation. During training, the pre-trained weights are frozen. With each weight matrix of the pre-trained model is associated a weight update matrix of identical size which is added to the pre-trained and frozen weight at each iteration of training.

In one embodiment, the weight update matrix is a product of two matrices, weight update factor matrices, such that the entries of the two matrices are all that need updating during training, and their product is added to the corresponding pre-trained weight matrix.

In another embodiment of the invention, the weight update matrix is expressed as a summation of outer products, wherein the dimensions of the outer products are a design specification, and wherein each component of the summation is sequentially designated as the learnable parameter during training. An outer loop serves to designate the pre-trained weight matrices and their respective corresponding learnable parameter matrices. An inner loop iteratively trains the model, changing the learnable parameters till stopping criteria are met and respective weight update matrices are obtained, at which point the outer loop updates the pre-trained matrices by adding their respective corresponding newly trained weight update matrices. The outer loop also updates the learnable parameter matrices by designating the next component of the composition of outer product matrices as the learnable parameter matrix. The described nested loop proceeds till stopping criteria are met.

As used herein and in the claims, the term “AI-based drug discovery and development task” includes, by way of non-limiting example: generation of candidate ligand representations for a target protein; generation of candidate ligand representations conditioned on a desired biased-signaling profile; generation of candidate ligand representations conditioned on similarity to, or dissimilarity from, a reference ligand; generation of candidate ligand representations conditioned on a multi-receptor selectivity profile; in silico prediction of one or more ligand attributes including without limitation absorption, distribution, metabolism, excretion, and toxicity (ADMET) attributes, binding affinity, functional agonism, functional antagonism, biased agonism, selectivity, pharmacokinetic attributes, and pharmacodynamic attributes; cross-validation of in silico predicted ligand attributes against in vitro or in vivo measurements of corresponding attributes of synthesized ligands; lead selection; lead optimization; scaffold hopping; target identification and druggability assessment; off-target liability assessment.

In one embodiment of the invention, a peptide ligand sequence is obtained for synthesis. By way of example and not limitation, the method of synthesis may include Solid-Phase Peptide Synthesis (SPPS), recombinant DNA technology, cell-free expression systems (or In Vitro Transcription and Translation (IVTT)), or mammalian expression systems.

In one embodiment of the invention, a small-molecule ligand representation is obtained for synthesis. The small-molecule ligand may be represented by way of example and not limitation as a Simplified Molecular-Input Line-Entry System (SMILES) string, a canonical or isomeric SMILES string, a SELFIES (Self-Referencing Embedded Strings) string, an International Chemical Identifier (InChI) string and associated InChIKey, a molecular graph in which nodes denote atoms and edges denote bonds, a set of three-dimensional atomic coordinates, a fingerprint or descriptor vector, or any other machine-readable encoding of chemical structure. In such an embodiment, the sequence output and the structure output of the model, or a dedicated chemical-structure output head thereof, emit tokens of the selected chemical representation. By way of example and not limitation, a small-molecule ligand so represented may be realized by chemical synthesis routes including solution-phase organic synthesis, solid-phase organic synthesis (SPOS), automated flow chemistry, combinatorial or parallel library synthesis, and enzymatic or biocatalytic synthesis, and may be selected, ranked, or filtered prior to synthesis according to synthetic accessibility, retrosynthetic feasibility, or commercial availability.

In the case of such small-molecule ligand embodiment, the low-rank adaptation disclosed herein is applied to fine-tune the pre-trained model toward generation of the small-molecule representation.

In one embodiment of the invention, a ligand generated and synthesized according to the disclosed methods is a diagnostic agent or a therapeutic agent, including without limitation an agonist, antagonist, biased agonist, partial agonist, inverse agonist, or modulator of a target receptor, and may be used in the diagnosis or treatment of a disease or condition associated with the target receptor.

In summary, the invention disclosed herein comprises systems and methods for low-rank adaptation, including via successive summation configurable compositions of outer product matrices, for fine-tuning pre-trained models for AI-based drug discovery and development tasks including protein and drug design.

The invention comprises several outlined processes below, and their relation to each other, as well as all modifications which leave the spirit of the invention invariant. The scope of the invention is outlined in the claims section.

### BRIEF DESCRIPTION OF THE DRAWINGS

In the following detailed description of the invention, we reference the herein listed drawings and their associated descriptions, in which:

FIG. 1 is an illustrative example of a G-Protein Coupled Receptor (GPCR), serving as a non-limiting example of a target receptor for which the invention is applicable.

FIG. 2 is a schematic of the product of two low rank matrices.

FIG. 3 is a schematic illustration of outer product summation of low-rank composition.

FIG. 4 is a schematic illustration of additive weight update fine-tuning.

FIG. 5 is a schematic illustration of a low-rank adaptation training on new target protein data.

FIG. 6 is a schematic of low-rank adaptation via successive outer product summation architecture.

FIG. 7 is a schematic of a transformer neural network training architecture embodiment on which low-rank adaptation can be performed.

FIG. 8 is a schematic of a transformer neural network inference architecture embodiment on which low-rank adaptation can be performed.

FIG. 9 is an example of a computing environment.

### DETAILED DESCRIPTION OF THE PREFERRED EMBODIMENTS

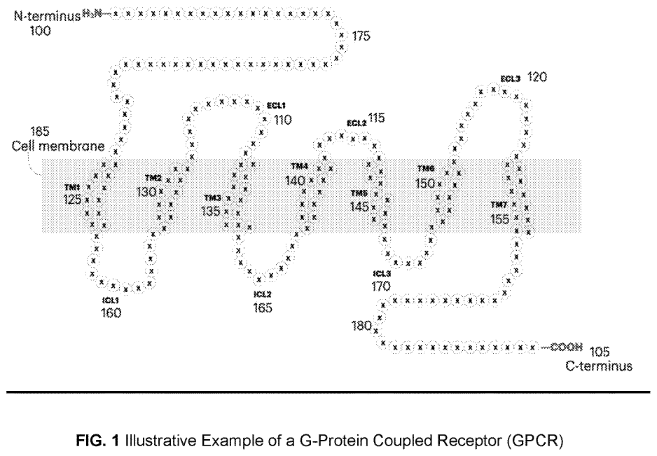

The illustration in FIG. 1 is of a G-Protein Coupled Receptor (GPCR), which serves as a non-limiting example of a target receptor for which the invention is applicable. With reference to FIG. 1, the GPCR comprises an extracellular N-terminus 100 and an intracellular C-terminus 105; three extracellular loops designated ECL1 110, ECL2 115, and ECL3 120; seven transmembrane domains designated TM1 125, TM2 130, TM3 135, TM4 140, TM5 145, TM6 150, and TM7 155; three intracellular loops designated ICL1 160, ICL2 165, and ICL3 170; an N-terminal extracellular chain segment 175; and a C-terminal intracellular chain segment 180. The GPCR, also called a 7 Transmembrane Receptor (7TMR), spans the cell membrane 185 seven times via its seven transmembrane domains. Individual amino acid residues of the receptor are depicted as circles containing an “X” character within the chain. The ligand-generating embodiments of the invention are not limited to GPCR ligands; other non-limiting examples of applicable target receptor classes include ion channels, enzymes, nuclear receptors, tyrosine kinase receptors, and insulin-like receptor families.

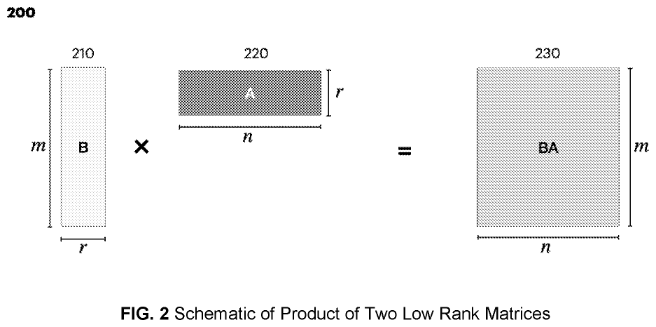

FIG. 2 illustrates a schematic 200 of the product of two low rank matrices. The matrix B 210 is an m×r matrix and the matrix A 220 is an r×n matrix; their product BA 230 is an m×n matrix. The low rank r is an architectural design hyperparameter or specification of the model. The low rank r can be chosen with the objective of being small enough such that the number of learnable parameters (m×r+r×n) is significantly smaller than the actual number of entries it updates, m×n.

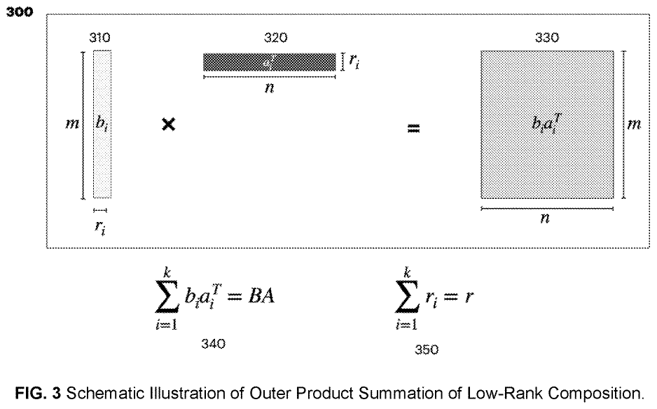

FIG. 3 illustrates a schematic 300 of outer product summation of low-rank composition. The matrix (or vector) b_i 310 is an m×r_i matrix (or vector) and the matrix (or vector) a_i\hat{ }T 320 is an r_i×n object; their product 330 is an m×n matrix. Notably, 340, the sum of outer products of the b_i and a_i\hat{ }T yields the full low rank matrix BA, 230. In tandem, the composition of the rank r into k components that are summed is such that their respective ranks r_i add up to r as shown in 350.

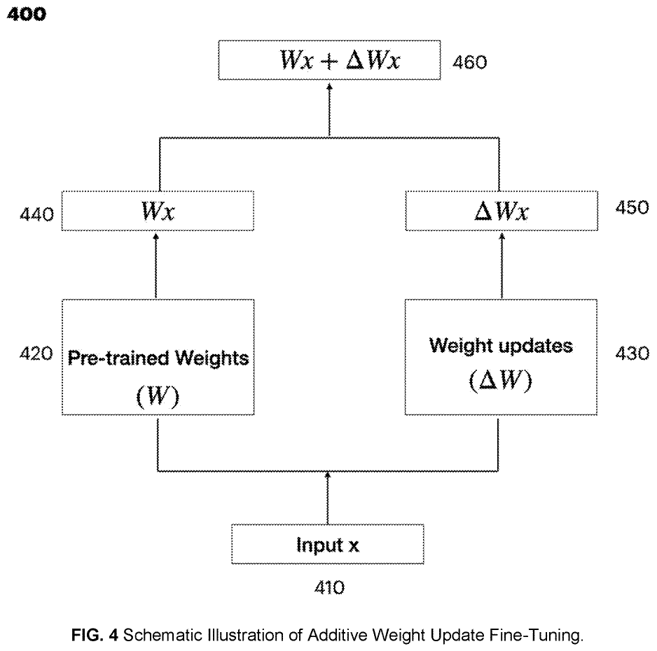

FIG. 4 is a schematic illustration, 400, of an additive weight update fine-tuning framework. Input data x, 410, enters and is acted on by both the pre-trained weight matrix, W, 420, and the weight update matrix 430, yielding respectively Wx, 440, and ΔWx, 450. The resulting matrix vector products are added together to get the output 460. The training process proceeds iteratively with the pre-trained weights frozen, while the weight updates are learned and iteratively added as shown till termination criteria are met. In contrast to standard fine-tuning that updates the pre-trained weight matrix in place, additive weight-update fine-tuning holds the pre-trained weight matrix W frozen and confines learning to a separate weight update ΔW, such that W remains available and unmodified throughout training.

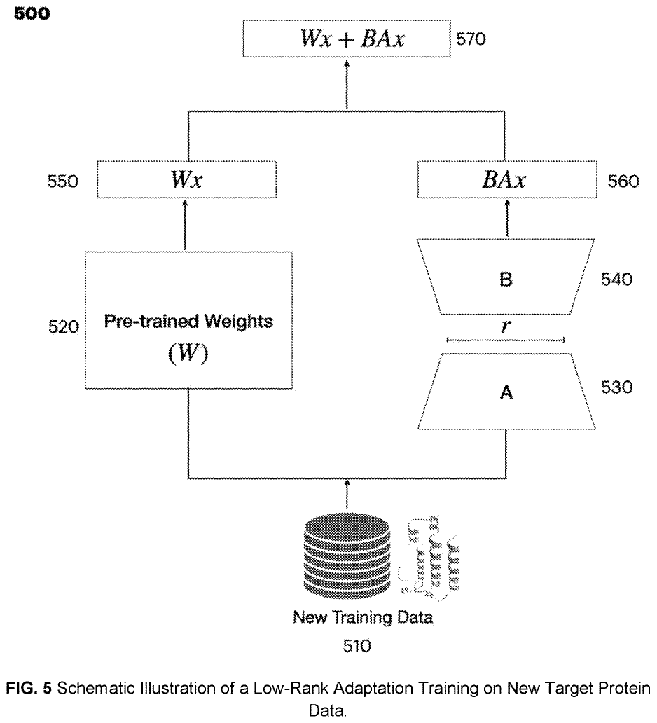

FIG. 5 is a schematic illustration, 500, of an embodiment of low-rank adaptation training on new target protein data, x, 510. The input target protein data x, 510, is acted on by pre-trained weight matrix 520, yielding a matrix vector product 550. Two low rank matrices A and B, 530 and 540 respectively, with A having r rows and B having r columns are multiplied together to get weight update matrix BA which multiplies the input x to yield matrix vector product BAx 560. The two resulting matrix vector products are added together to get the output 570. The training process proceeds iteratively with the pre-trained weights frozen, while the weight update matrices are learned and iteratively added as shown till termination criteria are met.

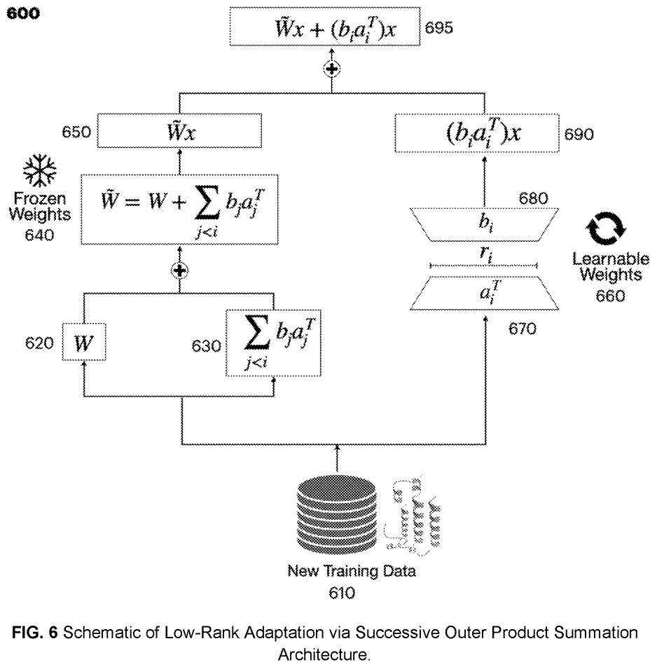

FIG. 6 is a schematic, 600, of low-rank adaptation via successive outer product summation architecture. New training data input, x, is shown in 610. The original pre-trained weight matrix W 620 is iteratively updated in the outer loop (following termination of each inner loop cycle), by adding the sum of preceding outer products 630. The preceding outer products (indexed as j<i, where i is the index of the current outer product learnable weight matrix in training) have each completed their training in the inner loop. The updated pre-trained weight matrix 640 is frozen and no longer learnable. The updated pre-trained weight matrix multiplies the input vector, yielding the product 650.

On the learnable side of FIG. 6, the learnable weight matrix 660 is obtained as an outer product of matrix a_i\hat{ }T 670 with r_i rows and matrix b_i 680 with r_i columns. The resulting outer product matrix multiplies the input, x, as shown, yielding the matrix vector product 690. The pre-trained matrix vector product, 650, is added to the learnable matrix vector product, 690, to yield the output 695. The training process proceeds iteratively with the pre-trained weights frozen, while the weight update matrices are learned and iteratively added as shown till termination criteria are met.

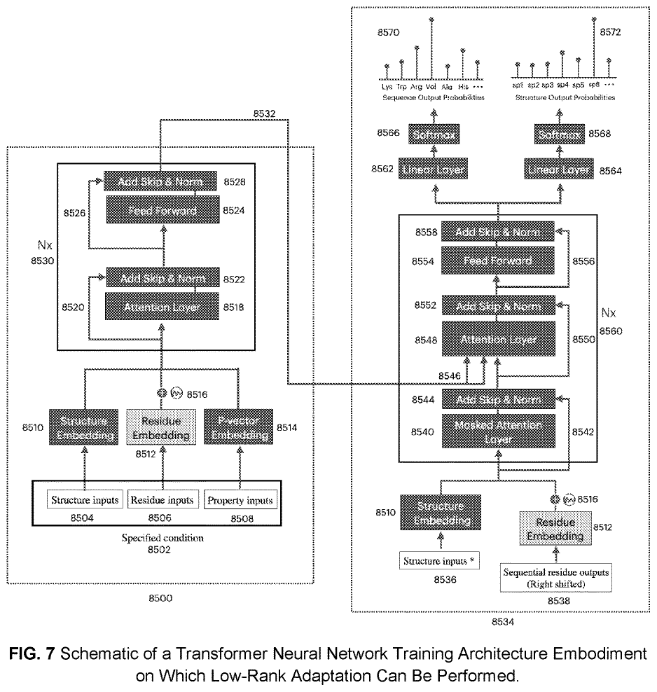

FIG. 7 is an illustrative example of a training architecture of a transformer neural network, by way of non-limiting example, with a sequence head and a structure head, accepting a specified condition comprising a structure input, a residue input, and a property input. The depicted network may be trained using the LoRA method disclosed herein.

With continued reference to FIG. 7, the training architecture encoder 8500 accepts a specified condition 8502 comprising a structure input 8504, a residue input 8506, and a property input 8508 into respective embedding layers: structure embedding 8510, residue embedding 8512, and a property vector (p-vector) embedding 8514. A positional encoding 8516 is added to the embedding outputs. The encoder includes an attention layer 8518 with a skip connection 8520 bypassing the attention layer, an Add Skip & Norm layer 8522, a feed forward layer 8524 with a skip connection 8526 bypassing the feed forward layer, and an Add Skip & Norm layer 8528. The encoder block module 8530 repeats N times. The encoder output passes via connection 8532 to the decoder.

The decoder 8534 receives a structure input 8536 and sequential residue outputs (right shifted) 8538. The decoder includes a masked attention layer 8540 with a skip connection 8542 bypassing the masked attention layer, an Add Skip & Norm layer 8544, a cross-attention input 8546 receiving encoder output 8532, a cross-attention layer 8548 with a skip connection 8550 bypassing the cross-attention layer, an Add Skip & Norm layer 8552, a feed forward layer 8554 with a skip connection 8556 bypassing the feed forward layer, and an Add Skip & Norm layer 8558. The decoder block module 8560 repeats N times. Above the decoder block module, a linear layer 8562 of the sequence head outputs to softmax layer 8566 to produce the sequence output probabilities 8570, and a linear layer 8564 of the structure head outputs to softmax layer 8568 to produce the structure output probabilities 8572. Low-rank adaptation per FIGS. 3-6 is applied to one or more weight matrices of the attention and/or feed-forward layers of the transformer of FIG. 7.

In some embodiments, the linear layer and softmax of the sequence head, the structure head, or a dedicated chemical-structure head, emit output probabilities over tokens of a chemical-structure representation, including by way of example and not limitation tokens of a SMILES, SELFIES, InChI, or molecular-graph representation, such that the depicted architecture generates a small-molecule ligand representation as described herein.

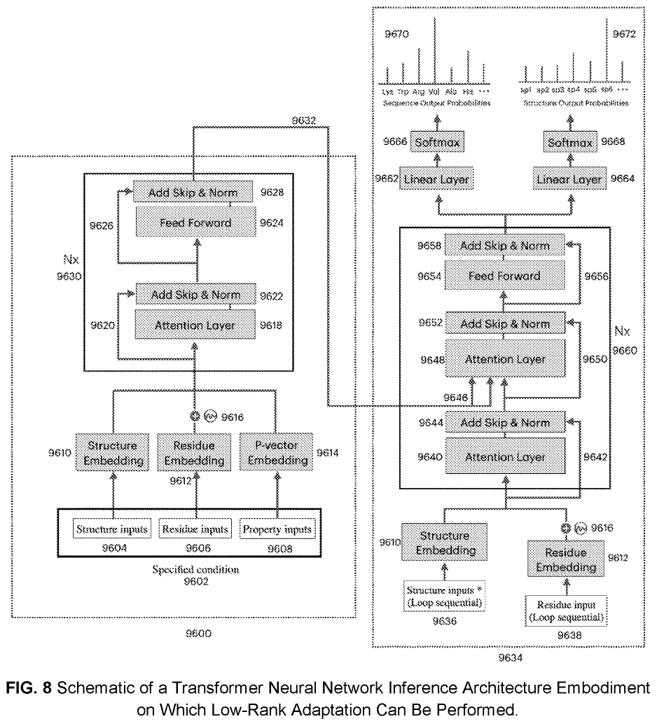

FIG. 8 is an illustrative example of an inference architecture of a transformer neural network, by way of non-limiting example, with a sequence head and a structure head, accepting a specified condition comprising a structure input, a residue input, and a property input. The depicted network embodies a neural network that may have been trained in accordance with the invention disclosed herein.

With continued reference to FIG. 8, the inference architecture encoder 9600 accepts a specified condition 9602 comprising a structure input 9604, a residue input 9606, and a property input 9608 into respective embedding layers: structure embedding 9610, residue embedding 9612, and p-vector embedding 9614. A positional encoding 9616 is added to the embedding outputs. The encoder includes an attention layer 9618 with a skip connection 9620 bypassing the attention layer, an Add Skip & Norm layer 9622, a feed forward layer 9624 with a skip connection 9626 bypassing the feed forward layer, and an Add Skip & Norm layer 9628. The encoder block module 9630 repeats N times. The encoder output passes via connection 9632 to the decoder.

The decoder 9634 receives a structure input (loop sequential) 9636 and a residue input (loop sequential) 9638. The decoder includes an attention layer 9640 with a skip connection 9642 bypassing the attention layer, an Add Skip & Norm layer 9644, a cross-attention input 9646 receiving encoder output 9632, a cross-attention layer 9648 with a skip connection 9650 bypassing the cross-attention layer, an Add Skip & Norm layer 9652, a feed forward layer 9654 with a skip connection 9656 bypassing the feed forward layer, and an Add Skip & Norm layer 9658. The decoder block module 9660 repeats N times. Above the decoder block module, a linear layer 9662 of the sequence head outputs to softmax layer 9666 to produce the sequence output probabilities 9670, and a linear layer 9664 of the structure head outputs to softmax layer 9668 to produce the structure output probabilities 9672.

With continued reference to FIG. 8, in some embodiments, the linear layer and softmax of the sequence head, the structure head, or a dedicated chemical-structure head, emit output probabilities over tokens of a chemical-structure representation, including by way of example and not limitation tokens of a SMILES, SELFIES, InChI, or molecular-graph representation, such that the depicted architecture generates a small-molecule ligand representation as described herein.

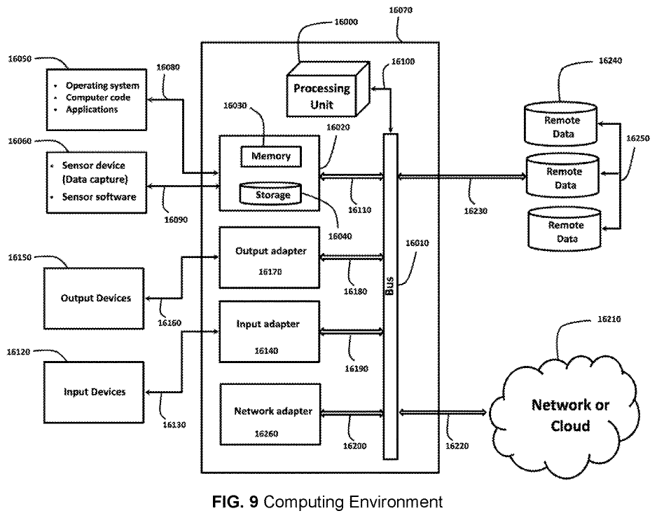

Those of ordinary skill in the art will recognize that the invention disclosed herein can be implemented over an arbitrary range of computing configurations. We will refer to any instantiation of these computing configurations as the computing environment. An illustrative example of a computing environment is depicted in FIG. 9. Examples of computing environments include but are not limited to desktop computers, laptop computers, tablet personal computers, mainframes, mobile smart phones, smart television, programmable hand-held devices and consumer products, distributed computing infrastructures over a network, cloud computing environments, or any assembly of computing components such as memory and processing—for example.

As illustrated in FIG. 9, the invention disclosed herein can be implemented over a system that contains a device or unit for processing the instructions of the invention. This processing unit 16000 can be a single core central processing unit (CPU), multiple core CPU, graphics processing unit (GPU), multiplexed or multiply-connected GPU system, or any other homogeneous or heterogeneous distributed network of processors.

In some embodiment of the invention disclosed herein, the computing environment can contain a memory mechanism to store computer-readable media. By way of example and not limitation, this can include removable or non-removable media, volatile or non-volatile media. By way of example and not limitation, removable media can be in the form of flash memory card, USB drives, compact discs (CD), blu-ray discs, digital versatile disc (DVD) or other removable optical storage forms, floppy discs, magnetic tapes, magnetic cassettes, and external hard disc drives. By way of example but not limitation, non-removable media can be in the form of magnetic drives, random access memory (RAM), read-only memory (ROM) and any other memory media fixed to the computer.

The computing environment can include a system board 16070.

As depicted in FIG. 9, the computing environment can include a system memory 16030 which can be volatile memory such as random access memory (RAM) and may also include non-volatile memory such as read-only memory (ROM). Additionally, there typically is some mass storage device 16040 associated with the computing environment, which can take the form of hard disc drive (HDD), solid state drive, or CD, CD-ROM, blu-ray disc or other optical media storage device. In some other embodiments of the invention the system can be connected to remote data 16240. Furthermore, the remote data store 16240 can consist of multiple parts connected to each other via an interface 16250.

The computer readable content stored on the various memory devices can include an operating system, computer codes, and other applications 16050, which can be connected via an interface 16080 to memory 16020. By way of example and not limitation, the operating system can be any number of proprietary software such as Microsoft Windows, Android, Macintosh operating system, iPhone operating system (iOS), or Linux commercial distributions. It can also be open source software such as Linux versions e.g. Ubuntu. In other embodiments of the invention, data processing software and connection instructions to a sensor device 16060 can also be stored on the memory mechanism. The procedural algorithm set forth in the disclosure herein can be stored on—but not limited to—any of the aforementioned memory mechanisms. In particular, computer readable instructions for training and subsequent tasks can be stored on the memory mechanism.

The computing environment typically includes a system bus 16010 through which the various computing components are connected and communicate with each other. The system bus 16010 can consist of a memory bus, an address bus, and a control bus. Furthermore, it can be implemented via a number of architectures including but not limited to Industry Standard Architecture (ISA) bus, Extended ISA (EISA) bus, Universal Serial Bus (USB), microchannel bus, peripheral component interconnect (PCI) bus, PCI-Express bus, Video Electronics Standard Association (VESA) local bus, Small Computer System Interface (SCSI) bus, and Accelerated Graphics Port (AGP) bus. The bus system can take the form of wired or wireless channels, and all components of the computer can be located remote from each other and connected via the bus system. By way of example and not of limitation, the processing unit 16000, memory 16020, input devices 16120, output devices 16150 can all be connected via the bus system. In the representation depicted in FIG. 9, by way of example and not limitation, the processing unit 16000 can be connected to the main system bus 16010 via a bus route connection 16100; the memory 16020 can be connected via a bus route 16110; the output adapter 16170 can be connected via a bus route 16180; the input adapter 16140 can be connected via a bus route 16190; the network adapter 16260 can be connected via a bus route 16200; the remote data store 16240 can be connected via a bus route 16230; and the cloud infrastructure can be connected to the main system bus via a bus route 16220.

In some embodiment of the invention disclosed herein, FIG. 9 illustrates that instructions and commands can be input by the user using any number of input devices 16120. The input device 16120 can be connected to an input adapter 16140 via an interface 16130 and/or via coupling to a tributary of the bus system 16010. Examples of input devices 16120 include but are by no means limited to keyboards, mouse devices, stylus pens, touchscreen mechanisms and other tactile systems, microphones, joysticks, infrared (IR) remote control systems, optical perception systems, body suits and other motion detectors. In addition to the bus system 16010, examples of interfaces through which the input device 16120 can be connected include but are by no means limited to USB ports, IR interface, IEEE 802.15.1 short wavelength UHF radio wave system (bluetooth), parallel ports, game ports, and IEEE 1394 serial ports such as FireWire, i.LINK, and Lynx.

In some embodiment of the invention disclosed herein, FIG. 9 illustrates that output data, instructions, and other media can be output via any number of output devices 16150. The output device 16150 can be connected to an output adapter 16170 via an interface 16160 and/or via coupling to a tributary of the bus system 16010. Examples of output devices 16150 include but are by no means limited to computer monitors, printers, speakers, vibration systems, and direct write of computer-readable instructions to memory devices and mechanisms. Such memory devices and mechanisms can include by way of example and not limitation, removable or non-removable media, volatile or non-volatile media. By way of example and not limitation, removable media can be in the form of flash memory card, USB drives, compact discs (CD), blu-ray discs, digital versatile disc (DVD) or other removable optical storage forms, floppy discs, magnetic tapes, magnetic cassettes, and external hard disc drives. By way of example but not limitation, non-removable media can be in the form of magnetic drives, random access memory (RAM), read-only memory (ROM) and any other memory media fixed to the computer. In addition to the bus system 16010, examples of interfaces through which the output device 16150 can be connected include but are by no means limited to USB ports, IR interface, IEEE 802.15.1 short wavelength UHF radio wave system (bluetooth), parallel ports, game ports, and IEEE 1394 serial ports such as FireWire, i.LINK, and Lynx.

In some embodiment of the invention disclosed herein some of the computing components can be located remotely and connected to via a wired or wireless network. By way of example and not limitation, FIG. 9 shows a cloud 16210 and a remote data source 16240 connected to the main system bus 16010 via bus routes 16220 and 16230 respectively. The cloud computing infrastructure 16210 can itself contain any number of computing components or a complete computing environment in the form of a virtual machine (VM). The remote data source 16240 can be connected via a network to any number of external sources such as NMR spectrometry devices, X-ray diffraction devices, electron microscopes, imaging devices, imaging systems, or imaging software.

In some embodiment of the invention disclosed herein, a sensor system 16060 which captures and pre-processes data is attached directly to the system. For example, this may be an electron microscope (and associated image processing software); it may be a camera in the case of an imaging system, say for processing distance map photographs; or it may be an X-ray crystallography machine or an NMR spectrometer (and associated software), etcetera. The sensor system can be connected to memory 16020 via an interface 16090. Stored in the memory mechanism—16020, 16240, or 16210—are machine learning models, algorithms, and data products developed according to the procedures set-forth herein. Computer-readable instructions are also stored in the memory mechanism, so that upon command, protein structure representation data, its substrates and associated data can be captured or can be received over a network from a remote or local previously collated database. This transmission of data can be done over a wired or wireless network as previously detailed, as the source and/or recipient of the data output can be at a remote location.

The objects set forth in the preceding are presented in an illustrative manner for reason of efficiency. It is hereby noted that the above disclosed methods and systems can be implemented in manners such that modifications are made to the particular illustration presented above, while yet the spirit and scope of the invention is retained. The interpretation of the above disclosure is to contain such modifications, and is not to be limited to the particular illustrative examples and associated drawings set-forth herein.

Furthermore, by intention, the following claims encompass all of the general and specific attributes of the invention described herein; and encompass all possible expressions of the scope of the invention, which can be interpreted as pertaining to language—as falling between the aforementioned general and specific ends.

What is claimed:

1. A method, comprising:
a) receiving, at a processor, a pre-trained neural network for an AI-based drug discovery and development task, the pre-trained neural network comprising a pre-trained weight matrix having dimensions m×n;
b) obtaining training data associated with the AI-based drug discovery and development task;
c) selecting a low rank r and a composition of the low rank r into k components having respective ranks r_1 through r_k, wherein a sum of the respective ranks r_i equals the low rank r;
d) associating with the pre-trained weight matrix a set of k outer product matrices corresponding to the composition, each outer product matrix of the set being a product b_i a_i\hat{ }T of a first factor b_i having dimensions m×r_i and a second factor a_i\hat{ }T having dimensions r_i×n, a summation of the set of k outer product matrices forming a weight update matrix for the pre-trained weight matrix;
e) fine-tuning the pre-trained neural network by an iterative process comprising an outer loop and an inner loop, wherein:
i) the outer loop designates as a learnable parameter matrix a previously undesignated outer product matrix of the set, while the pre-trained weight matrix, as updated by addition of each previously trained outer product matrix of the set, is frozen,
ii) the inner loop iteratively updates the designated learnable parameter matrix using the training data until a stopping criterion is met,
iii) upon the stopping criterion being met, the outer loop updates the pre-trained weight matrix by adding the designated outer product matrix thereto, and
iv) the iterative process repeats until each outer product matrix of the set has been designated or a termination criterion is met; and
f) outputting a fine-tuned neural network comprising the pre-trained weight matrix as updated by addition of each outer product matrix trained by the iterative process.

2. The method of claim 1, wherein the composition of the low rank r is non-uniform such that at least two of the respective ranks differ.

3. The method of claim 1, wherein each of the respective ranks equals one and k equals the low rank r, such that each of the k outer product matrices is a rank-one outer product.

4. The method of claim 1, wherein each of the k outer product matrices is trained by the iterative process and added to the pre-trained weight matrix.

5. The method of claim 1, wherein the AI-based drug discovery and development task comprises generating a candidate ligand representation for a target protein.

6. The method of claim 5, further comprising synthesizing a ligand according to the candidate ligand representation.

7. The method of claim 5, wherein the candidate ligand representation is generated conditioned on a desired biased-signaling profile.

8. The method of claim 1, wherein the AI-based drug discovery and development task comprises in silico prediction of one or more ligand attributes selected from the group consisting of absorption, distribution, metabolism, excretion, and toxicity (ADMET) attributes, binding affinity, functional agonism, functional antagonism, biased agonism, and selectivity.

9. The method of claim 1, wherein the pre-trained neural network comprises a transformer neural network having an encoder and a decoder.

10. The method of claim 9, wherein the transformer neural network accepts a specified condition comprising a structure input, a residue input, and a property input.

11. A method, comprising:
a) receiving a candidate ligand representation, the candidate ligand representation having been generated by a neural network fine-tuned for an AI-based drug discovery and development task by low-rank adaptation, wherein the low-rank adaptation comprises:
i) expressing a weight update matrix associated with a pre-trained weight matrix of the neural network as a summation of a set of outer product matrices corresponding to a composition of a low rank r into k components having respective ranks that sum to the low rank r, and
ii) training outer product matrices of the set successively, wherein a previously undesignated outer product matrix of the set is designated as a learnable parameter matrix and, upon completion of training of the designated outer product matrix, is added to the pre-trained weight matrix while the pre-trained weight matrix is otherwise frozen, and
iii) the successive training continuing until either each outer product matrix of the set has been so designated, trained, and added, or a termination criterion is met; and
b) synthesizing a ligand according to the candidate ligand representation.

12. The method of claim 11, wherein the ligand is a peptide.

13. The method of claim 11, wherein the candidate ligand representation comprises a machine-readable encoding of a small-molecule chemical structure selected from the group consisting of a SMILES string, a SELFIES string, an InChI string, and a molecular graph.

14. The method of claim 11, wherein the candidate ligand representation was generated conditioned on a target G-protein coupled receptor (GPCR).

15. The method of claim 11, wherein the composition of the low rank r is non-uniform such that at least two of the respective ranks differ.

16. A method, comprising:
a) receiving a synthesized ligand, the synthesized ligand having been synthesized according to a candidate ligand representation generated by a neural network fine-tuned for an AI-based drug discovery and development task by low-rank adaptation, wherein the low-rank adaptation comprises:
i) expressing a weight update matrix associated with a pre-trained weight matrix of the neural network as a summation of a set of outer product matrices corresponding to a composition of a low rank r into k components having respective ranks that sum to the low rank r, and
ii) training outer product matrices of the set successively, wherein a previously undesignated outer product matrix of the set is designated as a learnable parameter matrix and, upon completion of training of the designated outer product matrix, is added to the pre-trained weight matrix while the pre-trained weight matrix is otherwise frozen, and
iii) the successive training continuing until either each outer product matrix of the set has been so designated, trained, and added, or a termination criterion is met; and
b) assessing one or more biological activities of the synthesized ligand in vitro or in vivo.

17. The method of claim 16, wherein the synthesized ligand is a small-molecule drug.

18. The method of claim 16, wherein the synthesized ligand is a diagnostic agent or a therapeutic agent.

19. The method of claim 16, wherein the synthesized ligand is an agonist, antagonist, biased agonist, partial agonist, inverse agonist, or modulator of a target G-protein coupled receptor (GPCR).

20. The method of claim 16, wherein the composition of the low rank r is non-uniform and at least one of the respective ranks is greater than one.
